(19) United States
(12) Patent Application Publication
(10) Pub. No.: US 2020/0058070 A1
(43) Pub. Date: Feb. 20, 2020

(54) Systems and Methods for the Efficient Creation and Processing of Derivatives Trades

(71) Applicant: BL Exchange, llc, Boston, MA (US)

(72) Inventors: Jacob Mohs, Boston, MA (US); Eric Shahinian, New York, NY (US)

(21) Appl. No.: 16/281,163

(22) Filed: Feb. 21, 2019

Related U.S. Application Data
(60) Provisional application No. 62/719,370, filed on Aug. 17, 2018.

(51) Int. Cl. G06Q 40/04; G06F 17/27

(52) U.S. Cl. CPC G06Q 40/04; G06F 17/2705

(57) ABSTRACT

Methods and systems for providing efficient computations are provided, especially for producing derivatives contracts. One aspect of the invention includes a computer-implemented method of improving an efficiency of an electronic system. In such and embodiment, the method of the invention is applied in an electronic financial exchange system comprising at least one computer in electronic communication with one or more external data sources and at least one remote computer over a electronic communications network.

### 1 CROSS-REFERENCE TO RELATED APPLICATIONS

This application claims priority under 35 U.S.C. § 119(e) to provisional U.S. patent application Ser. No. 62/719,370 filed 17 Aug. 2018, the entire disclosure of which is incorporated herein by reference in its entirety and for all purposes.

### 2 NOTICE OF COPYRIGHT

Portions of this patent application include materials that are subject to copy-right protection. The copyright owner has no objection to the facsimile reproduction by anyone of the patent document itself, or of the patent application, as it appears in the files of the United States Patent and Trademark Office, but otherwise reserves all copyright rights whatsoever in such included copyrighted materials.

### 3 BACKGROUND OF THE INVENTION

### 3.1 Field of the Invention

The present invention provides systems, apparatus, software, and methods for improving system efficiencies, and more particularly to improving system efficiencies in electronic computer systems that generate derivatives contracts based on selected metrics for trading opportunities between parties and counter-parties.

### 3.2 The Related Art

Modern computer and network technology provides a degree of detail and sheer volume of information about the world that is unprecedented in history. Technologies such as artificial intelligence and “big data” enable the amassing and statistical assessment of mountains of data concerning nearly any subject of human activity. Subjects such public health, medical care, agriculture, the environment, natural resource distribution and extraction, transportation, production, and consumption, are all amenable to analysis at a degree of detail never before possible. Using modern techniques of mass data analysis, the current status, history, and future trends of all manner of activity across the globe is now tractable.

But the collection and analysis of mass data is not the only great leap forward in modern times. Using the same technologies in the forms of social media and Web-based technologies for electronic publication of data and opinions, the status and opinions of many individuals and organizations can be learned quickly and anonymously. All of this data can now be obtained, combined, and analyzed to understand and predict the actions of individuals and groups.

Given all of these advances, one obvious area of application would seem to be investing. Using the above-described technologies and their ability to collect and analyze data involving both masses and the fine points of individuals, the present time would be one of unprecedented investment opportunities. For example, the total return achieved by investors in any security can generally be broken into two components: (i) changes in the price or market value of that security, and (ii) income generated to the investor from that security during the holding period. For example, the total return from investing in traded equities consists of changes in stock price, and income earned from holding stocks (dividends or distributions). Stock price changes themselves can be decomposed into changes in corporate performance (measured by earnings, or something else), and changes in the valuation multiple placed by the market on that measure of corporate performance. Broader stock market performance can be extrapolated into the same, changes in corporate performance (especially exceeding expectations or not) and broad valuation change. Put differently the change in the price of a stock or group of stocks can be decomposed into the growth (or lack thereof) in a certain performance metric, and a change in the multiple on that metric. All of these can, in principle, be analyzed using the above-described technologies.

Related to drivers of total returns, the market price or valuation of a financial asset at any given time can be decomposed into some performance metric, and a multiple on that metric. For example, stock market investors place emphasis on price to earnings (“P/E”) ratios for most industries. Other widely used multiples include: enterprise value to EBITDA (“EV/EBITDA”), price to free cash flow (“P/FCF”), or enterprise value to free cash flow (“EV/FCF”). Other industries such as real estate, energy, mining, banking have multiples based on performance metrics very specific to that industry. Classic investment texts such as Ben Graham's Security Analysis emphasize the analysis of a business's financial data to determine a “fair value” of a particular security. The common approach is to compare the current multiple to a historical multiple measured at a comparable point in the business cycle and macroeconomic environment. An alternate approach is to compare current multiples to those of other companies, a sector or a market, and compare the current spread between them to a historical spread. However, one can also compare a stock's current multiple to a calculated fair or target multiple. At different points in the business cycle the “fair” and observed multiples are likely to differ. Fair multiples can be calculated based on a combination of specific performance metrics such as return on invested capital(“ROIC”). Generally a company earning a ROIC will have a higher fair value multiple, all else equal. For all these methods of valuation, the driving force is a specific corporate performance metric. Again, current technologies should provide an unprecedented level detail in understanding the predicting such factors.

Corporate performance measurements and valuation multiples often change in opposite directions and have opposing influence on investor returns. Either can fluctuate widely and impact investor outcomes even if the other remains steady. Financial performance for any company, however measured can fluctuate widely with industry developments. Academic research has verified that essentially all the stock market multiples experience wide dispersion both between industries or other groups of stock at a given time, and for the same security across time. Therefore, the drivers of stock market performance vary widely over time. Earnings are generally seen as the key driver of stock market performance. Other empirical research has indicated that earnings multiple is a key driver of stock market returns. One way to measure the frequent disconnect between corporate performance and stock performance is the wide variations in multiples. For example, the price to earnings ratio of the S&P 500 has fluctuated widely, from as low as 5.31 in 1917, to as high as 123 in 2009.

Although sub-components of total return or individual asset valuation often cancel each other out, most of the financial services industry devotes disproportionate resources to one or the other. The financial services industry devotes particularly significant resources to analysis and forecasting of granular sub-components of corporate performance. A large portion of sell-side and buy-side analysts devote most of their time to focusing on quarterly earnings. Many hedge funds devote significant resources to acquire extremely specific bits of information that are direct or indirect drivers of changes in corporate performance metrics. All this increasingly advanced activity is part of the process for correctly predicting the direction of corporate performance metrics such as earnings. Nonetheless a wide variety of factors besides corporate performance influence valuation, all of which are subject to analysis by practitioners and academics.

Generally, all these funds must apply their insights by making directional bets on stock price appreciation or depreciation. Even if they operate a hedged strategy, the performance of the strategy is still driven by stock price performance. This approach is clearly limited because the drivers of stock price appreciation when analyzed may frequently lead in the opposite direction. The current industry practice is for investors to develop ever more granular insights while continuing to implement these insights through the blunt instrument of stock price direction. If a fundamentals-oriented investor devotes substantially all their intellectual resources to the analysis of granular sub-components of sub-components of corporate performance, an investment that depends on simply the directional performance of a particular stock is less than ideal. The sub-components of stock market return frequently move against each other. Nonetheless investors generally bet on them as a collective package. It would be beneficial to have a method of betting on these drivers separately, and/or in various sub combinations. In current equity markets, investors do not yet have access to a market for instruments that are correctly aligned with their analytical abilities. Investors must use a blunt tool (stock price direction), in attempt to profit from a very granular insight. Consequently, investors with a genuine analytical edge on any given time horizon are not able to maximize the potential profits.

Developing a long-term insight into future company performance can be profited from in the long term, but an investor may need to bear significant short-term volatility, and without appropriate hedges. A sentiment-focused analyst may be blindsided by sudden change in corporate performance. There is currently no known method of properly hedging. A fundamentals-focused investor may be blindsided by sudden change in negative market sentiment either on a macro (general valuation trends) or micro level (company or industry specific). There is currently no known method of properly hedging: even if an investor has a broad and deep analytical abilities capable of analyzing the drivers of stock price changes, if they all point in opposite directions, in most cases they have no access to investment instruments that will allow them to profit from their insights. Alternatively, even if their investment ends up directionally right, they do not maximize profits because they must profit from the overall balance of contradicting factors, rather than being able to invest exclusively in a specific metric that they correctly predicted, e.g., quarterly earnings.

A variety of financial instruments have been developed or proposed for allowing investors to profit directly from more granular insights into corporate performance or other individual drivers of stock market returns. Nonetheless there does not yet exist a fully integrated system for operating a financial market, which allows investors to directly invest in one or more specific drivers of stock price return. Consequently, a new instrument is needed to maximize opportunities for alpha creation, and a better deployment of resources within capital markets. The present invention meets these and other needs.

### 4 SUMMARY OF EMBODIMENTS OF THE INVENTION

The present invention provides systems, methods, and software for creating and processing customized derivatives contracts efficiently.

In a first embodiment, the present invention provides a computer-implemented method of improving an efficiency of an electronic system. In such an embodiment, the method of the invention is applied in an electronic financial exchange system comprising at least one computer in electronic communication with one or more external data sources and at least one remote computer over a electronic communications network. The computer comprises at least one processor and at least one non-transitory computer-readable storage medium having computer-readable program instructions stored therein, which computer-readable program instructions, when executed, cause the at least one computer to perform the steps of: receiving parameters to define at least one derivative contract, the parameters including requests for executed financial statement data; polling the one or more external data sources for executed financial statement data, the polling comprising pulling, by the at least one computer over a channel, the executed financial statement data directly from the one or more external data sources at a predetermined rate that is determined, by the at least one computer, according to one or more assets associated with the executed financial statement data and independently of the one or more external data sources; and receiving the executed financial statement data responsive to the polling.

The method described above further includes determining that the executed financial statement data comprises data in a format other than a standard format, and executing further computer-readable program instructions embodied in a special purpose translator and a parser, responsive to the determining, thereby causing the at least one computer to perform the additional steps of: translating, via the special purpose translator, the executed financial statement data in the format other than the standard format into data having the standard format, the electronic financial exchange system configured to process executed financial statement data in the standard format and parsing, via the parser, the translated executed financial statement data to identify financial statement information; comparing the financial statement information to one or more parameters; and determining whether the financial statement information satisfies at least one of the one or more parameters.

The method further includes creating the at least one derivative contract based on the financial statement information only when it is determined that the financial statement information satisfies the at least one of the one or more parameters; and offering the derivative contract to one or more participants by automatically activating a graphical user interface on the remote computer to cause the graphical user interface to automatically display the one or more new proposed transactions.

In some more specific embodiments, the method just described further includes those wherein the one or more external data sources comprises one or more public feeds. Still more specific embodiments are those in which the one or more public feeds comprises published financial statement data. In yet more specific embodiments, the one or more public feeds is provided by a swap data repository.

In other embodiments of the method described above, wherein the parameters include at least one metric. In some embodiments, the published financial statement data includes: net income, earnings per share, EBITDA, EBITDA per share, revenue, revenue per share, gross income, gross income per share, operating earnings (EBIT), EBIT per share, free cash flow, free cash flow per share, operating cash flow, operating cash flow per share, industry-unique metrics, metrics for real estate investments, metrics for investment companies and business development companies, and net investment income. Still other embodiments further comprise calculating an estimated strike price for the derivative contract.

In still other embodiments, the method of the invention further comprises calculating an expected payout for the derivative contract. In more specific embodiments, the derivative contract is selected from the group consisting of: options, swaps, futures, or a user-defined contract.

In some embodiments, the invention includes mapping the executed financial statement data to the standard format of the electronic financial exchange system.

An electronic system with improved efficiency, comprising: an electronic exchange server comprising at least one processor and at least one non-transitory computer-readable storage medium having computer-readable program instructions stored therein, the electronic exchange server in electronic communication with one or more external data sources and a remote computer via a network, the computer-readable program instructions, when executed, causing the electronic exchange server to: poll the one or more external data sources for executed financial statement data, the polling comprising pulling, by the electronic exchange server over a channel, the executed financial statement data directly from the one or more external data sources at a predetermined rate that is determined, by the electronic exchange server, according to one or more assets associated with the executed financial statement data and independently of the one or more external data sources: receive the executed financial statement data responsive to the polling; determine that the executed financial statement data comprises data in a format other than a standard format; translate, by a special purpose translator on the electronic exchange server, the translator comprising computer-readable instructions causing the translator to convert the executed financial statement data in the format other than the standard format into data having the standard format, the electronic exchange server configured to process executed financial statement data in the standard format; parse, by a parser on the electronic exchange server, the translated executed financial statement data to identify trade information, the parser executing computer-readable instructions to perform the identifying; compare the trade information to one or more parameters; determine whether the trade information satisfies at least one of the one or more parameters; create one or more new proposed transactions based on the trade information only when it is determined that the trade information satisfies the at least one of the one or more parameters; and offer the one or more new proposed transactions to one or more participants by automatically activating a graphical user interface on the remote computer to cause the graphical user interface to automatically display the one or more new proposed transactions, wherein the parse function eliminates at least a portion of the executed financial statement data, thereby reducing computational processing of new trade offerings by the at least one processor and operational requirements of the at least one processor.

In some more specific embodiments, the method just described further includes those wherein the one or more external data sources comprises one or more public feeds. Still more specific embodiments are those in which the one or more public feeds comprises published financial statement data. In yet more specific embodiments, the one or more public feeds is provided by a swap data repository.

In other embodiments of the method described above, wherein the parameters include at least one metric. In some embodiments, the published financial statement data includes: net income, earnings per share, EBITDA, EBITDA per share, revenue, revenue per share, gross income, gross income per share, operating earnings (EBIT), EBIT per share, free cash flow, free cash flow per share, operating cash flow, operating cash flow per share, industry-unique metrics, metrics for Real Estate investment, trusts, funds from operations, modified funds from operations, metrics for investment companies, and business development companies, and net investment income. Still other embodiments further comprise calculating an estimated strike price for the derivative contract.

In still other embodiments, the method of the invention further comprises calculating an expected payout for the derivative contract. In more specific embodiments, the derivative contract is selected from the group consisting of: options, swaps, futures, or a user-defined contract.

In some embodiments, the invention includes mapping the executed financial statement data to the standard format of the electronic financial exchange system.

### 5 BRIEF DESCRIPTION OF THE DRAWINGS

Exemplary embodiments of the present invention are described herein with reference to the following drawings, in which:

FIG. 1 is a flowchart illustrating one embodiment of an exemplary embodiment of a method in accordance with the present invention.

FIGS. 2a-2d are illustrations of various aspects of exemplary embodiments of a user interface in accordance with the present invention. FIG. 2a illustrates an example of a initial user interface. FIG. 2b illustrates the interface with a dropdown menu for a number of companies that a user can select as the target for an analysis or derivative contract. FIG. 2c illustrates the interface with a drop-down menu for a number of metrics that a user can select for an analysis or derivative contract. FIG. 2d illustrates the interface with a drop-down menu for a number of contracts that a user can select for a derivative contract.

### 6 DETAILED DESCRIPTION OF SOME EMBODIMENTS OF THE INVENTION 6.1 Definitions

Unless indicated otherwise, the following terms and definitions will apply herein. Unless otherwise noted, the conjunction “or” as used herein is in its “inclusive”sense, i.e., “A or B” refers to either “A” individually, “B” individually, or “A and B” together; in other words, “or” as used herein, unless otherwise noted, is logically and grammatically equivalent to the expression “and/or”.
Computer The term “computer” shall refer to any electronic device capable of receiving, transmitting, processing, or otherwise using electronically encoded data. For example and without limitation, a “computer” as that term is used herein may serve one or more functions of a server, a processor, a microprocessor, a personal computing device (such as a laptop, personal digital assistant, desktop or workstation), a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing or communication device. Such devices will be familiar to those having ordinary skill in the art.
Network The term “network” shall refer to any type of electronic or computer network or combination of such networks, including those capable of being utilized in connection with an electronic exchange system as defined herein, such as, for example, any public, or private networks, including, for instance, the Internet, an intranet, or an extranet, any wired or wireless networks, or any combination thereof. Such devices will be familiar to those having ordinary skill in the art.
Electronic (Financial) Exchange Server (System) The terms “electronic exchange server”, “electronic exchange system””, and “financial exchange system” may be used interchangeably, and refer to any type of a computer, system, or combination of such, that is effective to perform electronic asset exchange transactions. For example without limitation, an electronic exchange system of the invention includes a commodities exchange, a futures execution facility, an options exchange, a cash equities exchange, a swap execution facility, an unregulated electronic transaction execution venue, or any other type of an exchange venue known in the art. The electronic exchange server may be configured to place buy or sell orders in connection with financial derivatives instruments over a network when the instructions are executed.
Asset The term “asset” shall refer to any type of financial instrument of any class, such as, without limitation, outright options, spread options, option combinations, commodities, derivatives, shares, bonds and currencies. The term “derivatives” shall further refer to any type of options, caps, floors, collars, structured debt obligations and deposits, swaps, futures, forwards and various combinations thereof or any other type of financial instruments that derive from another underlying financial instrument as described herein.
Trade The term “trade” shall refer to any type or part of a transaction or exchange that may occur in connection with one or more derivatives instruments as described herein.

### 6.2 Efficient Data Processing and Derivatives Trading Systems

The present invention provides systems and methods for improving an efficiency of electronic systems, and, more particularly, systems and methods for creating, offering, and trading derivatives contracts that enable far greater flexibility and efficiency than currently available. Using the methods and systems provided by the present invention, investors can more effectively create useful and relevant derivatives contracts and use such contracts to hedge other investments more effectively than currently possible. To accomplish these advantages, the present invention provides an efficient computer system and network to enable the creation and pricing of custom derivatives contracts (e.g., futures) using currently available economic, social, political, and financial information, inter alia, across various computer networks. The systems and methods provided herein require the power, speed, and precision of a special purpose computer programmed to execute the operations described herein; and therefore the present invention is not a mere method of organization, or a method that may be executed by a human in any realistic manner. Instead, the systems and methods described herein are necessarily rooted in computer technology in order to overcome a problem specifically arising in the realm of computer networks so as to provide an improvement in the functioning of a computer, computer system, or computer network in order to achieve a particular effect.

More particularly, the systems and methods provided by the present invention enable the rapid creation, offering, and trading of derivatives contracts based on user-defined metrics using currently available information relevant to such metrics. Such information is validated for its suitability for use with the metric. If the information fails to meet quality parameters (e.g., to establish its timeliness, suitability, desirability, or the like), then the information is excluded; thus, the invention described herein enables the creation, offering, and settling of user-defined derivatives trades, thereby improving the operating efficiency of derivatives markets.

Exemplary implementations of this disclosure may parse data received or pulled or extracted from external sources for an target company or industry or sector at a given point in time. Sources of such data include data published under regulatory or other legal requirements, e.g., such as those required under the Dodd-Frank Act, to publish trade data provided by Swap Data Repositories (“SDRs”) and similar such publicly available feeds, such as Options Price Reporting Authority (“OPRA”), European Market Infrastructure Regulation (“EMIR”) and Trade Reporting and Compliance Engine (“TRACE”) (same in cash equities and equity options, futures and options on futures, cash bonds, etc.) Still other sources include, but are not limited EDGAR, SEDAR, Companies House, and proprietary databases consisting of financial information for select or groups of private companies. Still more sources are commercial providers such as, but not limited to, Bloomberg, Sentieo, and Thomson Reuters.

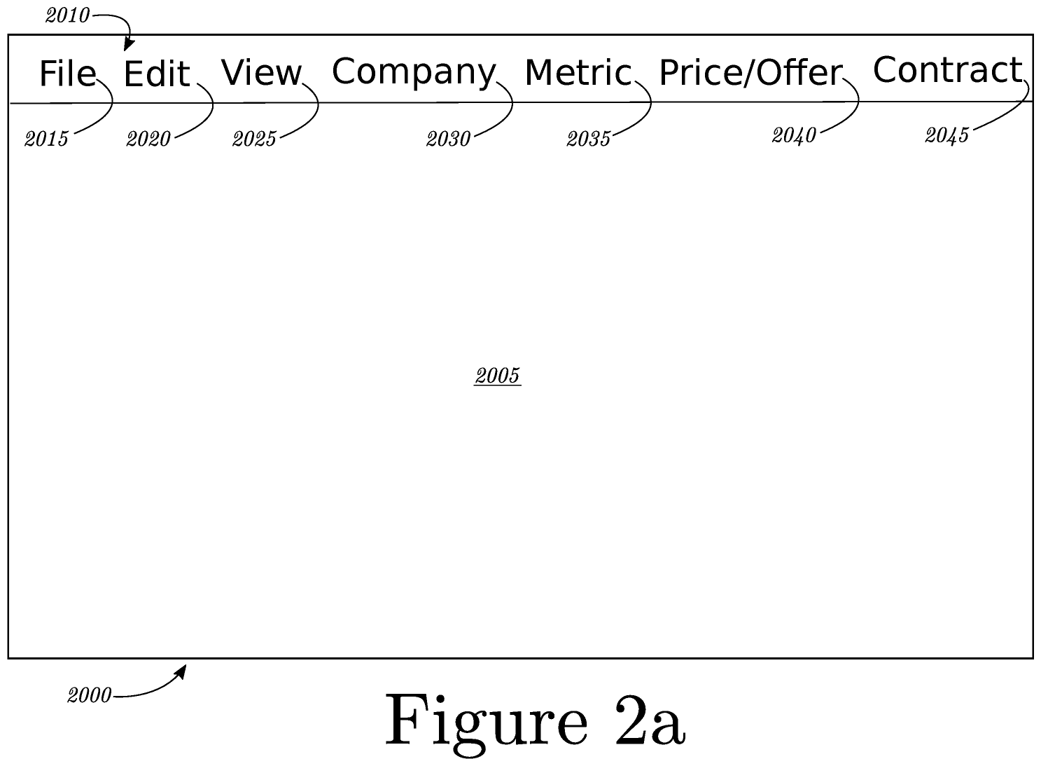

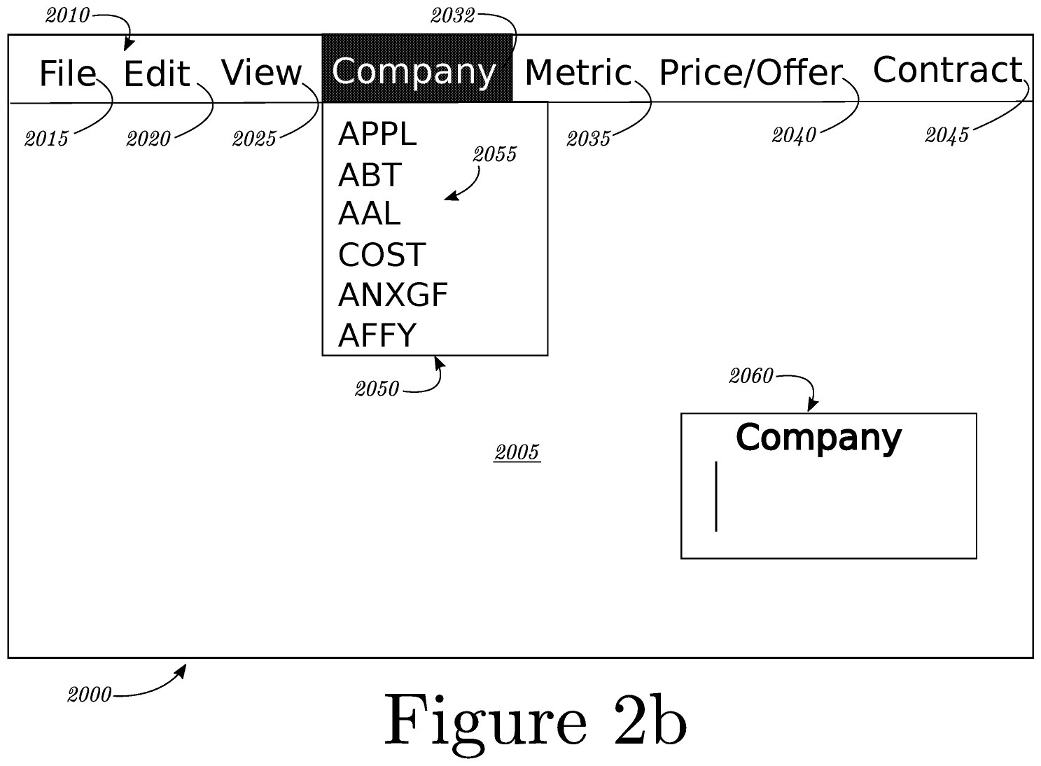

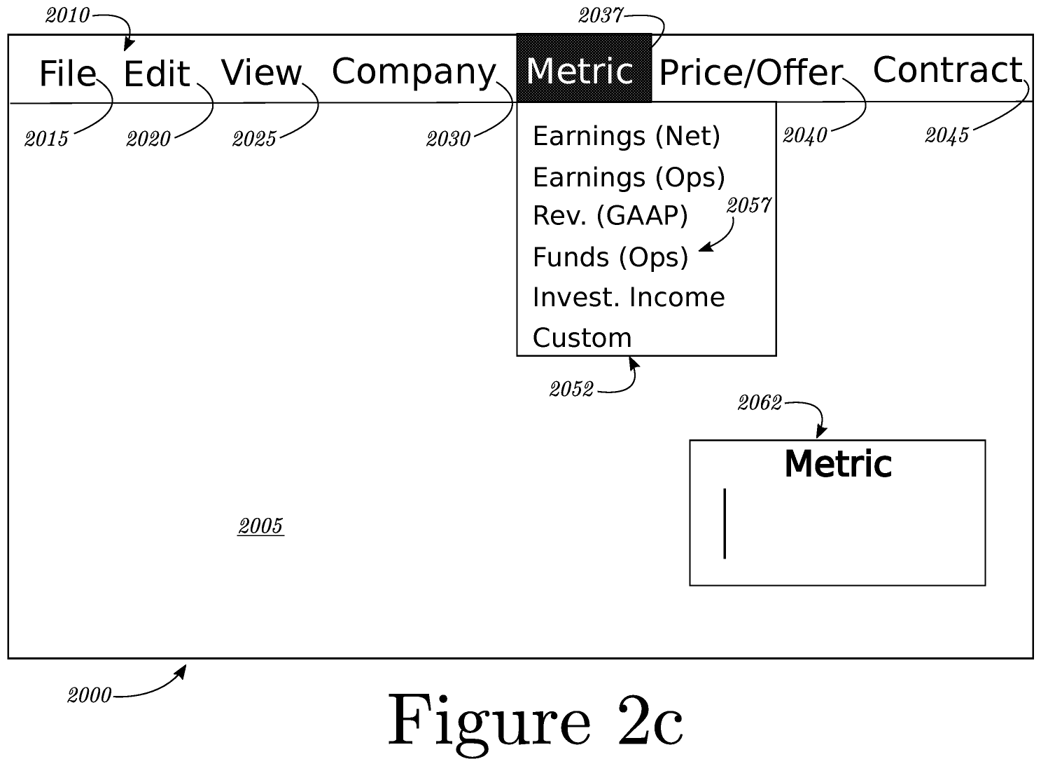

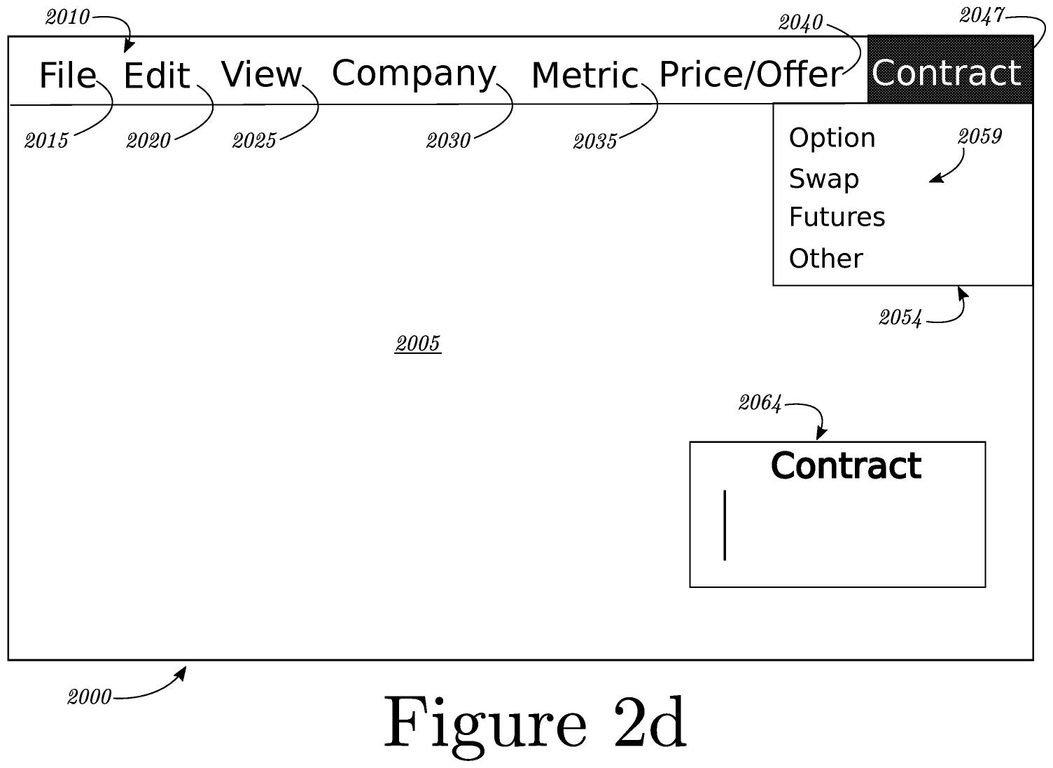

An exemplary system for improving efficiency while enabling the generation, offering, and settlement of derivatives contracts comprises a financial exchange system that may be an electronic exchange server, Swap Data Repositories (SDR), external (data) sources, and user devices. Each of the electronic exchange server, SDRs, external sources, and user devices may comprise one or more computing devices that include non-transitory memory for storing instructions and a processor for executing the instructions. The financial exchange system, SDRs, external sources, and user devices may communicate with each other over at least one network, including, but not limited to the Internet, Wi-Fi connections, cellular networks or any other wired or wireless connection or network known in the art. The user devices may comprise a desktop computer, a laptop, a smartphone, tablet, or any other user device known in the art. A user may interact with the financial exchange system via a graphical user interface (see, FIGS. 2a-2d) displayed on any type of display device including a computer monitor, a smart-phone screen, tablet, a laptop screen or any other device providing information to a user. The financial exchange system may be configured to receive market data relating to a financial asset from the SDR and external source.

Execution of the instructions may cause the financial exchange system to perform any of the features described above, and those further described below. A financial exchange system may be embodied on a single computing device, while in other embodiments, the financial exchange system may refer to a plurality of computing devices housed in one or more facilities that are configured to jointly provide computing services to remote devices. The financial exchange system may be configured to receive trade data for a financial asset such as from a public ticker, public feed, subscription ticker service or from another trading platform. The financial exchange system may be configured to receive trade data from open market sources, private market sources, internal sources, or from any other source. The trade data may include at least one parameter of an executed asset trade. The financial exchange system may be configured to offer a trade between two or more participants at the timely last executed trade price derived from the received trade data. The provision of such systems and their methods of operation will be familiar to those having ordinary skill in the art.

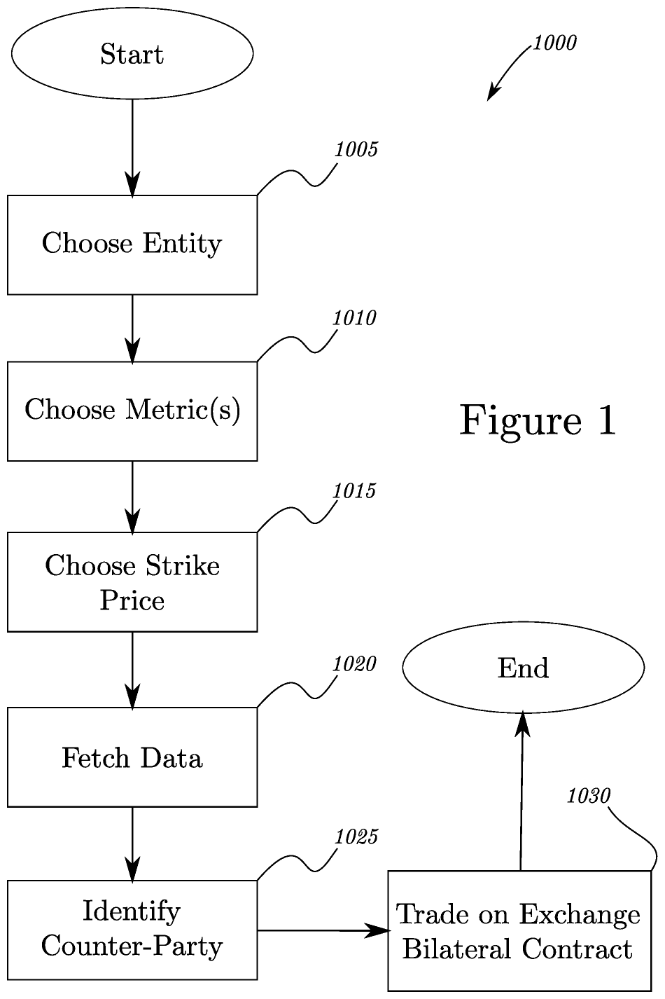

FIG. 1 shows an exemplary illustration of a method of practicing the present invention (1000). A user (e.g., a trader seeking to create a derivative to be traded with a counter-party), chooses an entity that will be the target or subject of the derivative (1005). Once the entity has been chosen, the user then chooses one or more metrics by which the derivative will be defined (1010). The user then chooses a strike price for the contract, or the the system can offer a calculated estimated strike price (1015). The data necessary to calculate the the chosen metric(s) is then retrieved (1020). At least one counter-party is then identified (1025). The contract is then traded on an exchange or in a binary transaction between the user and the counter-party(ies) (1030). The implementation of these steps will be familiar to those having ordinary skill in the art. The provision of such systems and their methods of operation will be familiar to those having ordinary skill in the art.

FIGS. 2a-2d illustrate an exemplary user interface in accordance with the present invention. Starting with FIG. 2a (2000), a display area (2005) is provided.

Across a menu bar (2010) a user is presented with various commands (20150-2045), including a File command (2015), Edit command (2020), a View command (2025), a Company command (2030), a Metric command (2035), a Price/Offer command (2040), and a Contract command (2045). The implementation of these steps will be familiar to those having ordinary skill in the art. In addition, variations on these commands that do not depart from the invention, and their implementation, will also be apparent to those having ordinary skill in the art. The File, Edit, and View commands are configured to perform operations commonly associated with those commands, and will not be discussed further. The provision of such systems and their methods of operation will be familiar to those having ordinary skill in the art.

FIG. 2b shows the same screen as illustrated in FIG. 2a, but with an activated Company menu (2032), showing a drop-down list (2050) of several ticker symbols for various companies (2055). A text box (2060) can also be provided to enter a specific metric without resorting to the menu. A user selects one or more of these symbols to define the target company of the derivative contract. In some embodiments, the invention provides a simple list of company identifiers (such as ticker symbols as shown) from which a user selects a desired target company. In other embodiments, the menu can be divided further into industrial, economic, or financial sectors, or other relevant forms of organizing company names for user convenience. The provision of such systems and their methods of operation will be familiar to those having ordinary skill in the art.

FIG. 2c shows the same screen as illustrated in FIG. 2a, but with an activated Metric menu (2037), showing a drop-down list (2052) of several metrics that are relevant to the company (or companies) chosen earlier (2057). A text box (2062) can also be provided to enter a specific metric without resorting to the menu. A user selects one or more of these metrics to define the metric(s) by which the derivative contract will be defined. In some embodiments, the invention provides a simple list of metrics from which a user selects a desired target company. In other embodiments, the menu can be divided further into other relevant forms of organizing metrics for user convenience. The provision of such systems and their methods of operation will be familiar to those having ordinary skill in the art.

FIG. 2d shows the same screen as illustrated in FIG. 2a, but with an activated Contract menu (2047), showing a drop-down list (2054) of several derivative contract types that are relevant to the company (or companies) chosen earlier (2059). A text box (2064) can also be provided to enter a specific contract type without resorting to the menu. A user selects one of these contract to define the terms by which the derivative contract will be defined. In some embodiments, the invention provides a simple list of contracts from which a user selects a desired target company. In other embodiments, the menu can be divided further into other relevant forms of organizing metrics for user convenience. The provision of such systems and their methods of operation will be familiar to those having ordinary skill in the art.

Once the data necessary to define a derivative contract is provided, e.g., as shown in FIGS. 2a-2d, an exemplary sequence of operations by which the data necessary to define the derivative contract (hereinafter the “data”) is retrieved will be described next. An electronic exchange server (or any other computing device(s) configured appropriately) procures and receives the data from an external source. The data may be published for a variety of reasons, such as due to legislation, regulatory or legal requirements, or a party may voluntarily publish trade data (e.g., for a fee or at no cost). The electronic exchange server may receive a plurality of external feeds.

In some embodiments, the electronic exchange server polls one or more public feed websites operated by one or more SDR(s) (or other external sources or feeds) at a predetermined rate based on one or more parameters (e.g., every few seconds) and scrapes (or pulls) data (e.g., executed trade data) from the public feed website(s) (e.g., ticker or other source) that may be provided in a text format, XML file or other document structure. The predetermined rate may be related to the type of trade data being polled or the type of assets to which the trade data pertains. The executed trade data may be pulled and received remotely over a network or it may be pulled or received locally. As should be understood, data from public tickers or public feeds may be utilized for a variety of purposes, across multiple asset classes, and in connection with any type of trade. The external source may be a public feed, such as from a swap data repository providing published trade data.

In some embodiments, the pulled data is mapped to a specified format. This process may be referred to as a “translation” of the data. For instance, the electronic exchange server may be further configured to translate the pulled executed trade data into a common format suitable for the electronic exchange system. Although standard identifier formats may be preferred for formatting trade data information, market participants often submit non-standard descriptors of a contract to hinder the spread of their information or to avoid potential licensing fees.

In some embodiments, a determination is as to the timeliness or suitability of the data is performed. Trade data that is not timely may be understood as out-of-date, stale, or untimely. The data may be compared to one or more pre-established parameters to determine if the data is still timely or otherwise suitable. Other parameters or factors may also (or alternatively) be considered to filter the data to determine whether it is timely or otherwise suitable for use in generating a metric. These factors may include, but not limited to: accuracy, relevance, reliability, etc. A predetermined allowable delay may be set to screen out data considered too old due to regulatory delay, technical delay, etc. The allowable time delay (e.g., the tolerance) of the data pulled by the electronic exchange server may depend on one or more factors including, the asset class, data source, trade parameters, and so forth, as noted above.

In addition to time delay, data may also be processed for accuracy, to ensure that the data is reliable. In some implementations, the parameters of the data may be evaluated and compared. Other parameters of the trade data may be cross-referenced with other data sources and analyzed to determine if the trade data is accurate or otherwise reliable and suitable. Another (non-limiting) characteristic that may be used to determine whether data is suitable include the relevance of the data in generating a derivative opportunity that is attractive to potential counter-parties.

Data may be analyzed to determine if estimated strike prices are within reasonable expectations. In particular, a determination may be performed of how different an estimated strike price is from the last known transaction or from a mid-market currently visible on an electronic trading platform. Strike prices may be based on historic data as well. The estimates may also indicate errors in data quality and eliminate the generation of volume clearing sessions that have a high likelihood of bad input data that would not generate interest from either side of a transaction.

Determination of timely data ensures that an excessive number of trade opportunities or volume clearing sessions are not generated, and that market participants are presented only with the trade opportunities that are most likely desirable and suitable for execution. In this manner, the systems and method of this disclosure is able to avoid or limit the generation and presentation of trade opportunities that are ultimately deemed unsuitable or undesirable, thereby reducing the processing requirements of the systems' component (e.g., electricity, processor capacity, memory, etc.) and increasing their respective operating efficiencies.

Timely trade data may also be determined based on predetermined events such as the release of economic news or other newsworthy events. For example, monetary policy announcements by the Federal Reserve with regard to interest rates may lead to an explosion of trading by high frequency traders immediately after the announcement. With high frequency trading, a platform may receive trade data for twenty (or more) trades on the same contract in less than a second which meet every other criteria for triggering a volume clearing session. However, simultaneously triggering twenty corresponding trades in such a short period of time may be impractical and create undue confusion for market participants on a platform.

### 6.3 Examples

Select key factors for various embodiments:

1. Database type
(a) Extract the financial statement data from a file of the financial statements placed into a proprietary database.
(b) Use web scraping techniques to gather financial statement data off public financial filings such as the EDGAR system in the US or SEDAR in Canada
(c) Extract secondary market equity trading data from a public source (Select yes or no)

2. Variation on extraction configurations
(a) GAAP/IFRS configurations
(b) Industry Specific Configuration

3. Chosen metric of analysis
(a) GAAP/IFRS Earnings
(b) Revenue
(c) EBIT/EBITDA
(d) Book Value at end of period
(e) Or other combined metrics such as ROIC, ROA, and ROE

4. Number of companies
(a) Single
(b) Industry or geographical grouping
(c) Predetermined index based on some other factor

5. Type of Security
(a) Option
   i. American/European
   ii. Binary Option
   iii. Forward/Future
   iv. Contract for Difference
(b) Other types of Security
   i. Notional value and contract sizes
   ii. Treatment
(c) Market infrastructure factors relevant to patent.
   i. Payment
   ii. Clearing
   i. Centralized
   ii. Use of decentralized ledger
(d) Settlement
   i. Unique types of Cash settled
(e) Margin
(f) Custody
(g) Others

### Example Use Case #1 (Speculation—Single Company)

Date: Dec. 15, 2015
Market capitalization: $100 m
Company filings indicate management expects $50 million in revenue, $20 million in operating earnings, and $10 m in net profit for 2016, approximately the same as the prior year.
Some analysts expect that the company's earnings will actually be $9.5 million in 2016.

Of these bearish analysts, some expect revenue and operating income to decline proportionally. Others expect that revenue will remain the same, but operating income and net profit will decline as the company is forced to accept lower margins because of increased competition in its industry.
Embodiments of the present invention scrape data from prior company filings and automatically generates a suite of standardized option contracts allowing investors to express their forecast for the Company's financial performance by buying the stream of earnings ahead of time. Expiration dates for the contract will be automatically scheduled around release of public filings.
John Jones is bullish on the company's earnings and wants to isolate his exposure to that by using the technological improvement created by the present invention. He can buy a call option on the earnings stream 20% above the projected earnings ($12 m in profit) for $10. This $10 entitles John to “buy” the $100 worth of earnings at $120. Bearish analysts can use the present invention to generate income by selling the standardized contract to John.
If earnings are $13 m, John breaks even.
If earnings are $20 m, John makes $70 in profit, a 7x multiple ($200 per $100 worth of earnings, less the strike of $120 and less the cost of $10).
If earnings are $8 m, John loses the $10.

### Example Use Case #1 (Hedge-Single Company)

Date: Dec. 15, 2015
Market capitalization: $100 m
Company projects $10 m in profit for 2016, the same as last year
Sell-side analyst projects $11 m in profit for 2016
As in Example 1, the present invention extracts company financial data, and performs calculations on this data, then automatically generates a set of standardized option contracts allowing investors to structure an investment directly based on the earnings stream. Transaction costs and operational difficulties are reduced through the automation and technology driven standardization of the present invention.
John Jones is bullish on the company but really he believes the company's earnings multiple will expand significantly when they announce earnings, which he thinks will be between the company and sell-side's estimates (+10%). He can sell a call option on the earnings stream 20% above the projected earnings ($12 m in profit) for $9. This $9 will allow John to “sell” $100 worth of earnings at $120.
He sells options in notional value equal to his long stock position. This will lower his cost to own the stock, if he is correct on the direction earnings, and thus isolate his investment more to the multiple expansion.

### 7 CONCLUSION

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

What is claimed:

1. A computer-implemented method of improving an efficiency of an electronic system, comprising: in an electronic financial exchange system comprising at least one computer in electronic communication with one or more external data sources and at least one remote computer over a electronic communications network, said at least one computer comprising at least one processor and at least one non-transitory computer-readable storage medium having computer-readable program instructions stored therein, said computer-readable program instructions, when executed, causing said at least one computer to perform the steps of:
receiving parameters to define at least one derivative contract, said parameters including requests for executed financial statement data;
polling said one or more external data sources for executed financial statement data, said polling comprising pulling, by said at least one computer over a channel, said executed financial statement data directly from said one or more external data sources at a predetermined rate that is determined, by said at least one computer, according to one or more assets associated with said executed financial statement data and independently of said one or more external data sources;
receiving said executed financial statement data responsive to said polling;
determining that said executed financial statement data comprises data in a format other than a standard format;
executing further computer-readable program instructions embodied in a special purpose translator and a parser, responsive to said determining, thereby causing said at least one computer to perform said additional steps of:
translating, via said special purpose translator, said executed financial statement data in said format other than said standard format into data having said standard format, said electronic financial exchange system configured to process executed financial statement data in said standard format and parsing, via said parser, said translated executed financial statement data to identify financial statement information; comparing said financial statement information to one or more parameters;
determining whether said financial statement information satisfies at least one of said one or more parameters;
creating said at least one derivative contract based on said financial statement information only when it is determined that said financial statement information satisfies said at least one of said one or more parameters; and
offering said derivative contract to one or more participants by automatically activating a graphical user interface on said remote computer to cause said graphical user interface to automatically display said one or more new proposed transactions.

2. The method of claim 1, wherein said one or more external data sources comprises one or more public feeds.

3. The method of claim 2, wherein said one or more public feeds comprises published financial statement data.

4. The method of claim 3, wherein said one or more public feeds is provided by a swap data repository.

5. The method of claim 4, wherein said published financial statement data includes: earnings per share, EBITDA, and revenue.

6. The method of claim 1, further comprising calculating an expected payout for said derivative contract.

7. The method of claim 1, wherein said derivative contract is selected from the group consisting of: options, swaps, futures, or a user-defined contract.

8. The method of claim 1, further comprising calculating an estimated strike price for said derivative contract.

9. The method of claim 1, further wherein said parameters include at least one metric.

10. The method of claim 1, further comprising: mapping said executed financial statement data to said standard format of said electronic financial exchange system.

11. An electronic system with improved efficiency, comprising: an electronic exchange server comprising at least one processor and at least one non-transitory computer-readable storage medium having computer-readable program instructions stored therein, said electronic exchange server in electronic communication with one or more external data sources and a remote computer via a network, said computer-readable program instructions, when executed, causing said electronic exchange server to:
poll said one or more external data sources for executed financial statement data, said polling comprising pulling, by said electronic exchange server over a channel, said executed financial statement data directly from said one or more external data sources at a predetermined rate that is determined, by said electronic exchange server, according to one or more assets associated with said executed financial statement data and independently of said one or more external data sources: receive said executed financial statement data responsive to said polling;
determine that said executed financial statement data comprises data in a format other than a standard format;
translate, by a special purpose translator on said electronic exchange server, said translator comprising computer-readable instructions causing said translator to convert said executed financial statement data in said format other than said standard format into data having said standard format, said electronic exchange server configured to process executed financial statement data in said standard format;
parse, by a parser on said electronic exchange server, said translated executed financial statement data to identify trade information, said parser executing computer-readable instructions to perform said identifying; compare said trade information to one or more parameters;
determine whether said trade information satisfies at least one of said one or more parameters;
create one or more new proposed transactions based on said trade information only when it is determined that said trade information satisfies said at least one of said one or more parameters; and
offer said one or more new proposed transactions to one or more participants by automatically activating a graphical user interface on said remote computer to cause said graphical user interface to automatically display said one or more new proposed transactions, wherein said parse function eliminates at least a portion of said executed financial statement data, thereby reducing computational processing of new trade offerings by said at least one processor and operational requirements of said at least one processor.

12. The system of claim 11, wherein said one or more external data sources comprises one or more public feeds.

13. The system of claim 11, wherein said one or more public feeds comprises published financial statement data.

14. The system of claim 11, wherein said one or more public feeds is provided by a swap data repository.

15. The system of claim 14, wherein said published financial statement data includes: earnings per share, EBITDA, and revenue.

16. The system of claim 11, further comprising calculating an expected payout for said derivative contract.

17. The system of claim 11, wherein said derivative contract is selected from the group consisting of: options, swaps, futures, or a user-defined contract.

18. The system of claim 11, further comprising calculating an estimated strike price for said derivative contract.

19. The system of claim 11, further wherein said parameters include at least one metric.

20. The system of claim 11, further comprising: mapping said executed financial statement data to said standard format of said electronic financial exchange system.
